(19) United States
(12) Patent Application Publication
(10) Pub. No.: US 2019/0065314 A1
(43) Pub. Date: Feb. 28, 2019

(54) MEMORY

(71) Applicant: Hewlett Packard Enterprise Development LP, Houston, TX (US)

(72) Inventors: Derek Alan Sherlock, Boulder, CO (US); Harvey Ray, Friderick, CO (US)

(21) Appl. No.: 16/082,262

(22) PCT Filed: Mar. 22, 2016
(86) PCT No.: PCT/US2016/023541

§ 371 Date: Sep. 4, 2018

(51) Int. Cl. G06F 11/10; G06F 11/20; G06F 3/06

(52) U.S. Cl. CPC G06F 11/1088; G06F 11/2089; G06F 3/0689; G06F 3/0619; G06F 11/1092

(57) ABSTRACT

A memory device may operate in multiple modes. In a first mode, writes are not committed. In a second mode, writes are committed.

### BACKGROUND

Storage and memory systems may employ redundancy schemes to ensure that data is not lost in the event of a device error or failure. An example of a redundancy scheme is a redundant array of independent disks (RAID). In some redundancy schemes, data may be striped across multiple memory or storage modules, data may be mirrored such that copies of the data are stored on multiple modules, and parity data may be stored on one or more modules of the redundant set.

### BRIEF DESCRIPTION OF THE DRAWINGS

Certain examples are described in the following detailed description and in reference to the drawings, in which:

FIG. 1 illustrates an example system in which the described technology may be implemented;

FIG. 2 illustrates an example method of incorporating a spare memory device into a set of redundant memory devices;

FIG. 3 illustrates an example state diagram of system operation;

FIG. 4 illustrates a method of operating a memory device during incorporation of the memory device as a spare device into a redundant set of memory devices;

FIG. 5 illustrates an example memory device; and

FIGS. 6A-6E are various bounce diagrams illustrating example system operations during various phases of bringing up a spare memory device.

### DETAILED DESCRIPTION OF SPECIFIC EXAMPLES

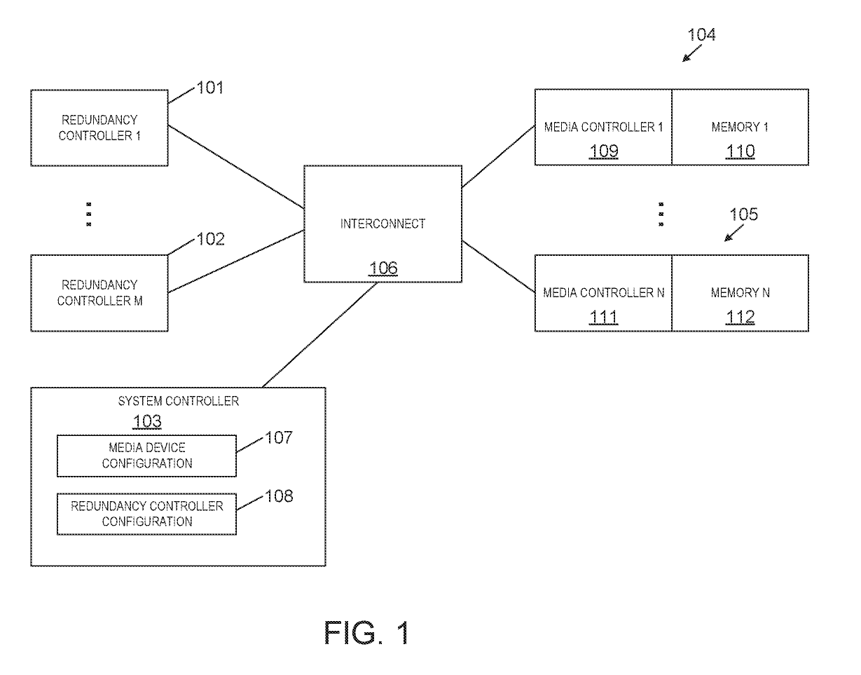

Examples of the described technology allow spare memory devices to replace failed devices in systems employing distributed redundancy controllers. FIG. 1 illustrates an example system in which the described technology may be implemented. The system includes a set of M redundancy controllers 101, 102 and a set of N memory devices 104, 105. The redundancy controllers 101, 102 are connected to the set of memory devices 104, 105 via an interconnect network 106. For example, the interconnect 106 may be a memory fabric or other interconnect supporting direct load/store access to memory devices 104, 105.

Each media device 104, 105 may include a media controller 109, 111 and a memory 110, 112. Each media controller 109, 111 may comprise an ASIC, firmware or software executed on a processor, a field programmable gate array (FPGA), or a combination thereof. Each media controller 109, 111 may provide one or more interfaces to the interconnect network 106 and may receive and send communications on the network 106. For example, the media controller 109 may receive read and write commands addressed to it, and may access the memory 110 according to the commands. The memory 110, 112 may comprise a non-persistent memory such as dynamic random access memory (DRAM); a persistent memory such as memristor, phase change RAM (PCRAM), resistive RAM (reRAM), or Flash memory; or a combination thereof.

The system may further include a system controller 103. For example, the system controller 103 may be a component of a system management card, a baseboard management controller, a chassis manager, a remote management system, a process running on a host server, or a component of designated master redundancy controller. In some implementations, the system controller's 103 functionality may be implemented by software or firmware executed by a processor, by hardware, or a combination thereof. For example, the system controller 103 may include an application specific integrated circuit (ASIC), an embedded processor, and a memory configured to perform the illustrated functionality.

The set of memory devices 104, 105 form a redundant set of memory devices. Units of data may be striped across the redundant set such that consecutive units are stored on different members of the set and parity data for the stripe is stored a member of the set. In some cases, the data may be stored in manners similar to RAID schemes. For example, the data may be stored in a RAID-4 manner, such that one memory device stores only parity and each other memory devices store only data. As another example, the data may be stored in a RAID-5 manner, such that parity blocks are stored in different devices for different stripes and each device includes data for some stripes and parity for other stripes.

The redundancy controllers 101, 102 issue commands to the memory devices 104, 105 to maintain the redundant set. For example, a redundancy controller 101 may be a component, such as an ASIC, connected to a memory controller of a host server processor to translate commands issued by the memory controller into the appropriate commands for the redundant set. As another example, a host server memory controller may be configured to participate directly in the redundant set such that the memory controller is one of the redundancy controllers 101, 102.

In some implementations, the portion of a given stripe stored on a single device (a “block”) has the same size as the cache lines of the host processors connected to the redundancy controllers. In these implementations, each stripe may be a number of cache lines. For example, in a RAID 5 configuration where each stripe is two data blocks and one parity block, each stripe may correspond to two cache lines.

In other implementations, each block may be larger than a cache line. For example, in a RAID 5 configuration where each stripe is two data blocks and one parity block, each data block may correspond to multiple cache lines. In these examples, each cache line access may read or write only a portion of a block. Other implementations may support other granularities of block sizes.

Modifications to a stripe may require more than one primitive operation. For example, writing a 64-byte cache line may require multiple reads and writes to multiple devices 104, 105. For example, it may be necessary to read the previous parity value from one device 104, read the previous data value from another device 105, then write the new data value to one device 104, and finally write the new parity value to another device 105. The previous data and parity values are needed in order to correctly calculate the new parity value to be written.

To enable concurrent access to the redundant set of memory devices 104, 105, by a set of redundancy controllers 101, 102, the system may implement a stripe locking protocol. Each media controller 104, 105 may maintain stripe locks with the parity data stored on its respective memory 110, 112. Prior to writing to writing to a stripe, the lock for the parity block of the stripe must be acquired by the redundancy controller 101, 102 that will update the stripe. While a redundancy controller 101 possesses the lock, other redundancy controllers 102 cannot obtain a lock for the stripe. Without the lock, other redundancy controllers 102 can read any of the data blocks within the stripe, but cannot complete a write sequence. This allows modification to a stripe to be performed as an atomic operation despite requiring multiple primitive operations.

If a memory device 104 of the set of devices 104, 105 fails, the redundancy controllers 101, 102 may detect the failure when attempting to access the failed device 104. Upon detecting the failure, the redundancy controllers 101, 102 may enter a degraded mode of operation. In the degraded mode, the redundancy controllers 101, 102 only read and write to the remaining devices, and write such that the contents of the remaining devices are what they would be if the failed device had not failed. In other words, if the failed device stored a data block for a particular stripe, updating the stripe may comprise updating the parity block so that the parity information allows recovery of the missing data block. If the failed device stored a parity block, updating the stripe may comprise updating the data block.

The system controller 103 may include a block 107 to configure media devices 104, 105. Block 107 may be a component of an ASIC, software or firmware executed by a processor, or a combination thereof. The system controller 103 may use block 107 to incorporate a new spare device after a memory device fails. The incorporation of the spare device may be coordinated to avoid race conditions or hazards by operating the spare device in an initial temporary mode and, later, a normal mode.

Additionally, the spare device's contents are initialized with invalid tags to indicate that its contents are not ready for consumption. The redundancy controllers 101, 102 treat an invalid tag returned from a device read as an indication that the block is unavailable. When this occurs, the redundancy controller obtains a stripe lock if it does not already hold one, reconstructs the missing data or parity block from the remainder of the stripe, and attempts to overwrite the invalid-tagged block to re-establish redundancy, and releases the lock. If this occurs as a part of a read, the reconstructed data satisfies the read. If it occurs as part of a write sequence, the values written or attempted to be written to the data and parity blocks reflect the write data. The outcome of the write sequence depends on the operational mode of the spare device.

The system controller 103 may further include a block 108 to configure the redundancy controllers 101, 102. Block 108 may be a component of an ASIC, software or firmware executed by a processor, or a combination thereof. The system controller 103 may use block 108 to instruct each redundancy controller 101, 102 to recognize the spare device.

Until each of the redundancy controllers recognizes the spare device, the spare is operated in a temporary mode where writes are discarded. This may prevent race conditions or other hazard that may occur if some of the redundancy controllers are not aware of the spare device. Causing the failed device to ignore write commands avoids race conditions or hazards that would occur if some redundancy controllers were operating in normal mode while others were operating in degraded mode.

In this mode, the memory device accepts write commands and, if applicable to the protocol, transmits acknowledgement messages indicating that the write command was successful. However, any write commands sent to the device are not committed. For example, the media controller may drop the write data specified by the uncommitted write commands. As another example, the media controller may write the received write data to memory but not unset the corresponding invalid tag after writing the data.

In the first mode of operation, the memory device may respond to read requests. However, the requested data will have an associated invalid tag. Accordingly, the memory device will respond to a read request with an indication that the requested data is invalid. In some cases, this response may be a designated poisoned data response. For example, the response may have the same format as a response that is provided when data is poisoned for failing a CRC or incurring an uncorrectable ECC error.

After each redundancy controller has been instructed to recognize the spare, the system controller 103 may use block 107 to transition the spare device to a normal operational mode where writes are committed. These writes will begin clearing the invalid tags. Additionally, the system controller may then use block 108 to instruct one or more redundancy controllers to begin rebuilding the contents of the spare device.

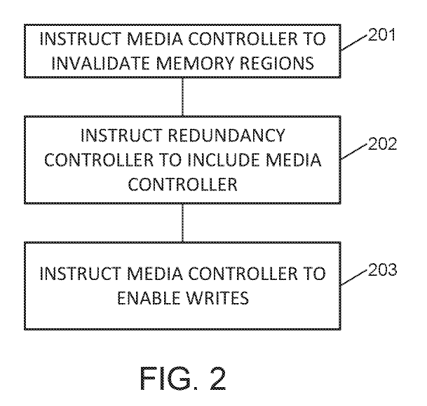

FIG. 2 illustrates an example method of incorporating a spare memory device into a set of redundant memory devices. For example, the method may be performed by a system controller, such as the system controller 103 of FIG. 1.

The example method includes step 201. Step 201 includes instructing a media controller to invalidate each memory region of a set of memory regions. For example, the set of memory regions may be the set of memory regions that will be used to replace the failed memory device. For example, the set of memory regions may be the entire memory device. The media controller may be a media controller of a memory device including the set of memory regions.

Step 201 may be performed by sending a command to the media controller to tag a set of blocks with invalid tags. The invalid tags may indicate that the data stored in the associated memory region(s) is not safe to consume. In some implementations, each block may have associated metadata and each block may be separately tagged as invalid using its associated metadata. For example, the metadata may include a poison bit used to indicate whether the corresponding block is valid. For example, the media controllers may periodically scrub the data on the media device to perform checks, such as cyclic redundancy checks (CRCs) or error checking and correction operations (ECC). The poison may be indicated by the deliberate use of a bad CRC encoding or an uncorrectable CRC encoding.

The example method further includes step 202. Step 202 includes instructing a set of redundancy controllers to include the media controller in a redundant set. In this example, prior to step 202, any redundancy controller that tries to access the failed device will enter a degraded mode as described above.

For these controllers, step 202 may comprise identifying the new spare device and instructing the redundancy controllers to include the new device in the redundant set as a replacement for the failed device. In some cases, some redundancy controllers may not have attempted to access the redundant set since the device failure. For these redundancy controllers, step 202 may comprise identifying the new spare device and instructing the redundancy controllers to use the new device in place of the failed device.

The example method further includes step 203. Step 203 may include after instructing the set of redundancy controller to include the media controller, instructing the media controller to enable writes. Prior to step 203, the media controller does not enable writes. As described above, incoming writes are received and acknowledged, but not committed to the memory device. This prevents race conditions or hazards that could otherwise occur if some redundancy controllers were operating in degraded mode while others were operating in normal mode.

In some implementations, step 203 is performed at least a threshold length of time after instructing the last redundancy controller to include the media controller in the redundant set. This period of time is sufficient to allow any in-flight degraded mode operations to complete. In some cases, this period of time may vary according to system architecture. For example, the period of time may depend on the architecture of the network connecting the redundancy controllers and memory devices, the system's routing protocols, and the memory communication protocols. In other cases, this period of time may be set to be a sufficient length to allow any in-flight operations to complete for any compatible system architecture.

In other implementations, step 203 is performed upon another trigger event. For example, each redundancy controller may keep track of in-progress degraded mode operations. For example, each redundancy controller may have a hardware device, such as a state machine, that keeps track of this information. The system controller may poll the redundancy controllers to ensure that all degraded mode operations have completed prior to performing step 203.

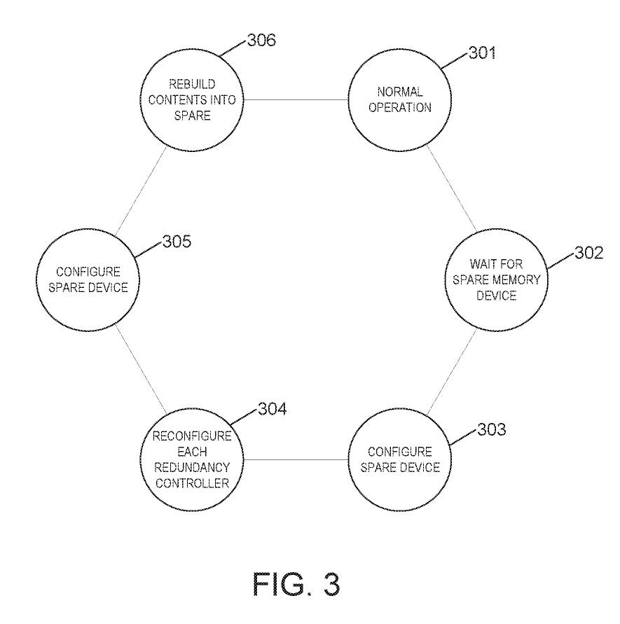

FIG. 3 illustrates an example state diagram of system operation. For example, FIG. 3 may illustrate various states that a system such as the system of FIG. 1 may operate in. The system begins in a normal operational state 301.

Upon failure of a memory device of the set of redundant device, the system enters state 302. Redundancy controllers may detect failure of the failed device asynchronously, but consistently and enter degraded mode upon detecting the failure. Here, consistently means that when a memory device fails, the failure is not intermittent and so none of the redundancy controllers can successfully access the device once it fails.

State 302 comprises waiting for a spare memory device. In some cases, one or more spare devices may be connected to the memory interconnect during normal operation 301. In these cases, state 302 may comprise allocating one of the spares to replace the failed memory device. In other cases, an administrator may need to install the spare memory device. In some instances, the spare device may be directly swapped in for the failed device.

In some instances, state 302 may include causing each redundancy controller into degraded mode prior to bringing the spare device online. This may avoid hazards that could occur if the spare device maintains the same network identity as the failed device. A potential hazard in this situation occurs if a redundancy controller is not in degraded mode when the spare is first brought online. For example, the redundancy controller may not have tried to access the failed memory device after it failed but before the spare was brought online. In some implementations, the system controller may explicitly place each redundancy controller that did not discover the failed device on its own into degraded mode. As another example, a redundancy controller that discovers that a device has failed could broadcast the identity of the failed device to the other redundancy controllers of the set.

Once the spare device is available, the system enters state 303. State 303 may comprise the system controller configuring the spare memory device. For example, the system controller may instruct the spare device to invalidate its memory contents. In some instances, state 303 may further comprise the system controller instructing the media controller to ignore writes.

After the spare device has been configured, the system enters state 304. In state 304, the system controller reconfigures each redundancy controller to recognize the spare device. In some implementations, the redundancy controllers do not recognize the spare device synchronously. For example, the system controller may broadcast the command to incorporate the spare device to the set of memory controllers, but the message may reach different redundancy controllers at different times. As another example, the system controller may individually instruct the redundancy controllers to recognize the spare device. Accordingly, during state 304, some redundancy controllers may be operating in degraded mode, while others are attempting to operate in normal mode. However, because the spare device ignores writes, the spare device content remains tagged as invalid, and so will not yet be relied upon to supply valid data nor parity for any stripe. The redundancy controllers that are attempting to operate in normal mode still have to resort to reconstructing missing data blocks upon read, in cases where the data would ordinarily have come from the spare device. Thus, degraded and normal mode behaviors from different redundancy controllers can safely intermix without resulting in the data integrity hazards, since no reads or writes yet depend upon stripe consistency. In state 304, redundancy has not yet been established, since each stripe continues to have one block tagged as invalid—either a data block or a parity block.

After each redundancy controller recognizes the spare device, the system enters state 305. In state 305, the spare device is configured to enable writes. For example, state 305 may comprise the system controller instructing the media controller of the spare device to commit writes. Read and write sequences that encounter the invalid-tagged data in the spare device will still have to reconstruct the missing data or parity block values, just as they would do in degraded mode, and they will still attempt to write corrected and consistent data to the spare device. But, unlike in the earlier state 304, these sequences succeed in overwriting the invalid-tagged blocks. Reads and writes thus have the side-effect of rebuilding stripes back into a consistent state and restoring their redundancy. Stripes that have been rebuilt in this manner coexist with other stripes have not—since the rebuilding is a side effect of the pattern of read and write accesses by redundancy-controllers. Each stripe remains free of data/parity inconsistency hazards—some because data/parity consistency and full redundancy has already been reestablished, and others because the invalid-tagged blocks continue to ensure that their spare-drive content will not be relied upon as being valid.

After the spare device is configured to commit writes, the system enters state 306. In state 306, the contents of the failed device are rebuilt into the spare using the redundant information stored in the other devices of the redundant set. Once the spare device is configured to commit writes, in state 306, the system controller may instruct a redundancy controller to begin a rebuild operation. In the rebuild operation, the redundancy controller may walk through each stripe, acquiring the stripe locks and rebuilding the failed device's block for that stripe onto the spare device. In some cases, the system controller may instruct multiple redundancy controllers to perform the rebuild operation. For example, the system controller may assign a set of stripes to rebuild to each redundancy controller assisting in the rebuild operation. This rebuilding differs from the rebuilding already occurring as a side-effect of ongoing accesses, which began in state 305, in that it methodically rebuilds all stripes, not only those that happen to be the target of an access. Upon completion of this rebuild sequence, full redundancy has been restored for all stripes.

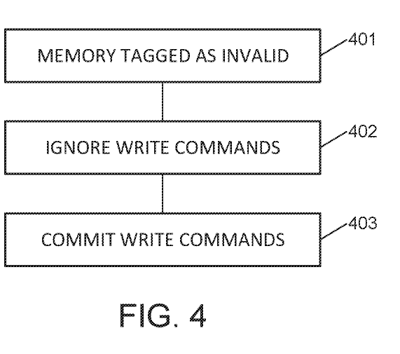

FIG. 4 illustrates a method of operating a memory device during incorporation of the memory device as a spare device into a redundant set of memory devices. In some implementations, the method may be performed by a media controller of a memory device.

The method may include step 401. Step 401 may include tagging a set of memory regions as invalid. In some implementations, the memory device may initiate step 401 upon command. For example, the media controller may receive an instruction to tag the set of memory regions as invalid from a system controller. In some implementations, the memory regions tagged as invalid may be stripe blocks. For example, the memory regions may be cache line sized blocks. In other implementations, other granularities of memory region sizes may be employed.

The method may include step 402. In step 402, the memory device operates in a first mode of operation. In the first mode of operation, the memory device ignores any received write commands. For example, the media controller may receive write commands, and if applicable to the memory communication protocol, acknowledge those write commands. However, the memory regions corresponding to the write commands remain invalidated. For example, the write commands may be dropped by the media controller or the data may be written but the corresponding invalid tag is kept set.

The method may further include step 403. In step 403, the memory device may operate in a second mode of operation. The second mode of operation may include the device's media controller receiving and committing write commands. For example, the second mode of operation may be a normal mode of operation. In some implementations, the memory device may transition from the first mode of operation to the second mode of operation upon command from the system controller.

In the second mode of operation, when the memory device receives a read command for a region that is tagged as invalid, the memory device will respond with an indication that the requested data is invalid. In some cases, this will trigger the requesting redundancy controller to rebuild the correct data for the region using the remaining data from the rest of the stripe, clearing the invalid tag and restoring the correct data to region. Although the memory device will respond to read requests in the same fashion during the first and second modes of operation, any resulting stripe rebuild operations will succeed in restoring redundancy in the second mode, whereas the ignored writes will prevent the restoration of redundancy in the first mode.

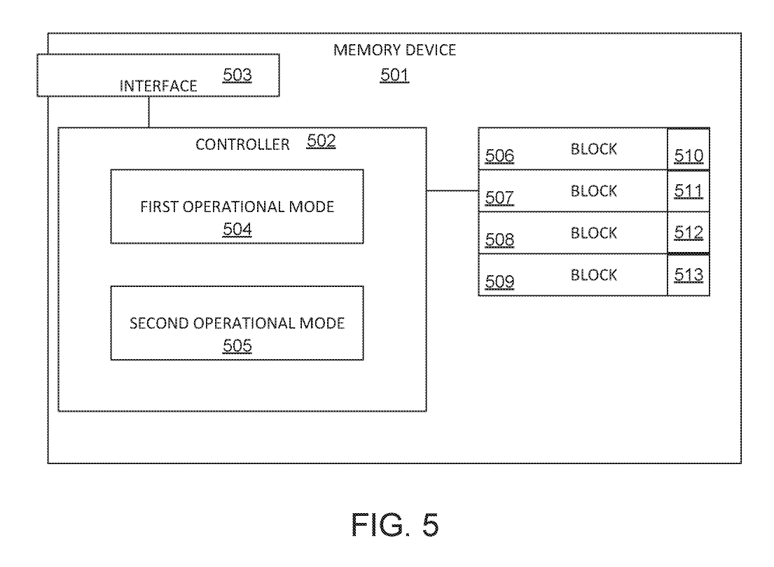

FIG. 5 illustrates an example memory device 501. The example memory device 501 may be used an element of a system such as the system of FIG. 1. For example, the example memory device 501 may be a memory device 104, 105 of a redundant set of memory devices.

The example memory device 501 includes a set of blocks 506, 507, 508, 509. Each block may comprise a set of memory cells and may be sized according to the portion of a stripe that is stored on the memory device 501 when the device is an element of a redundant set of memory devices. For example, each block 506-509 may be the size of a cache line of a host processor connected to a redundancy controller in communication with the memory device 501.

In this example, each block 506, 507, 508, 509 has a corresponding validity tag 510, 511, 512, 513. The validity tags are used to indicate whether the corresponding blocks are valid or otherwise safe for consumption by a requesting device. The tags 510-513 may be bits set at locations reserved for metadata. For example, the invalid tags may comprise poison bits. The tags may also contain values such as CRC or ECC codes protecting the data in normal use, but where certain particular encodings represent invalid-tagging of the data. For example, any uncorrectable error encodings, whether CRC or ECC, may be used as an indication of invalid-tagged data. In another example, only specific encodings may be reserved for this purpose—such as maximum-hamming-distance ECC encodings. The use uncorrectable error encoding values as invalid tags may be convenient, because the action taken upon encountering an uncorrectable error in a block, and the action taken upon encountering an invalid-tagged block, may be identical, in both cases triggering a tripe rebuild behavior by the redundancy controller.

The device 501 further includes a media controller 502. For example, the media controller 502 may hardware such as ASICs, firmware or software executed by an embedded processor, or a combination thereof. The media controller 502 may be able to operate in a first mode of operation. In the first mode of operation, write commands are not committed. For example, the media controller 502 may receive write commands via the interface 503. If required by the communication protocol, the media controller 502 may acknowledge the write commands or provide other required functions to indicate that the write commands were successful. In other words, in the first mode of operation, the memory device 501 appears to be a properly operating device to the redundancy controllers. However, in the first mode of operation, the media controller 502 drops the writes, performs the writes without unsetting the invalidity tag, or otherwise fails to commit received write commands.

The media controller 502 is further able to operate in a second mode of operation where received write commands are committed. For example, the second mode of operation may be a normal mode of operation. In some cases, the media controller 502 may receive a command to transition from the first mode of operation to the second mode of operation via the interface 503. For example, the media controller 502 may receive the command from a system controller.

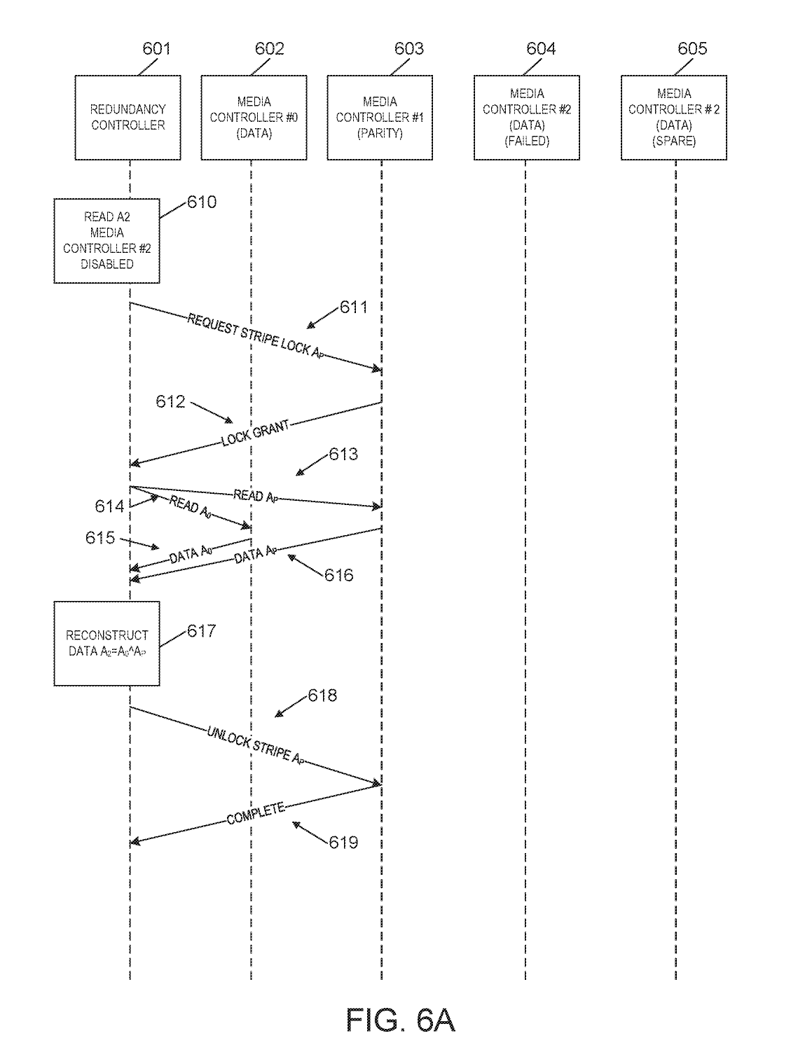

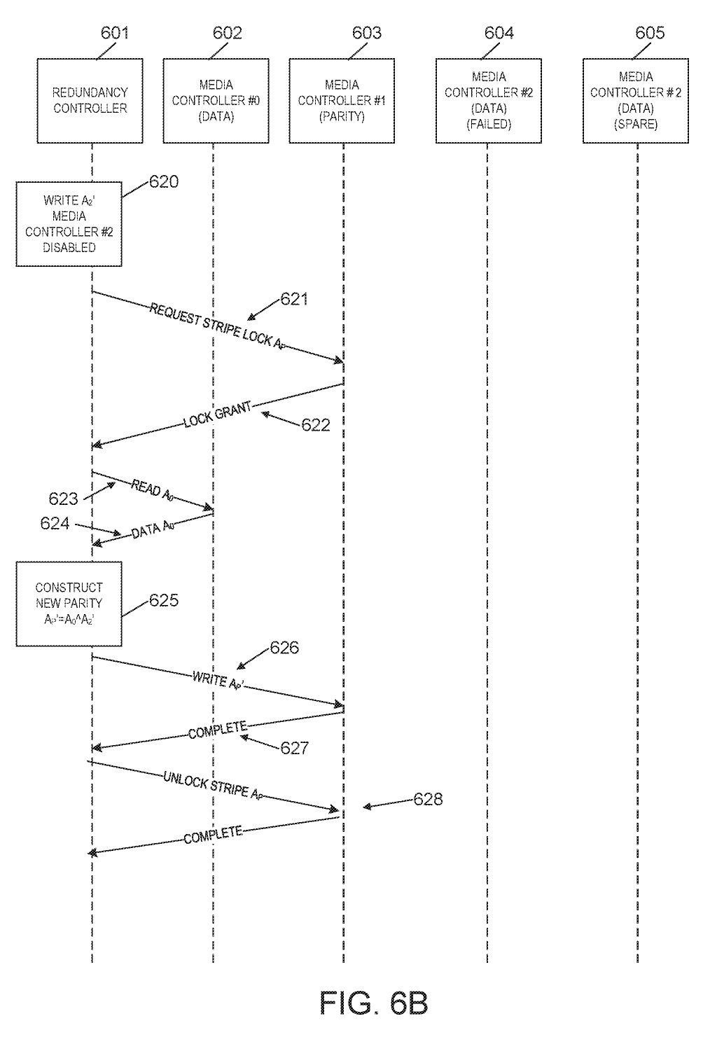

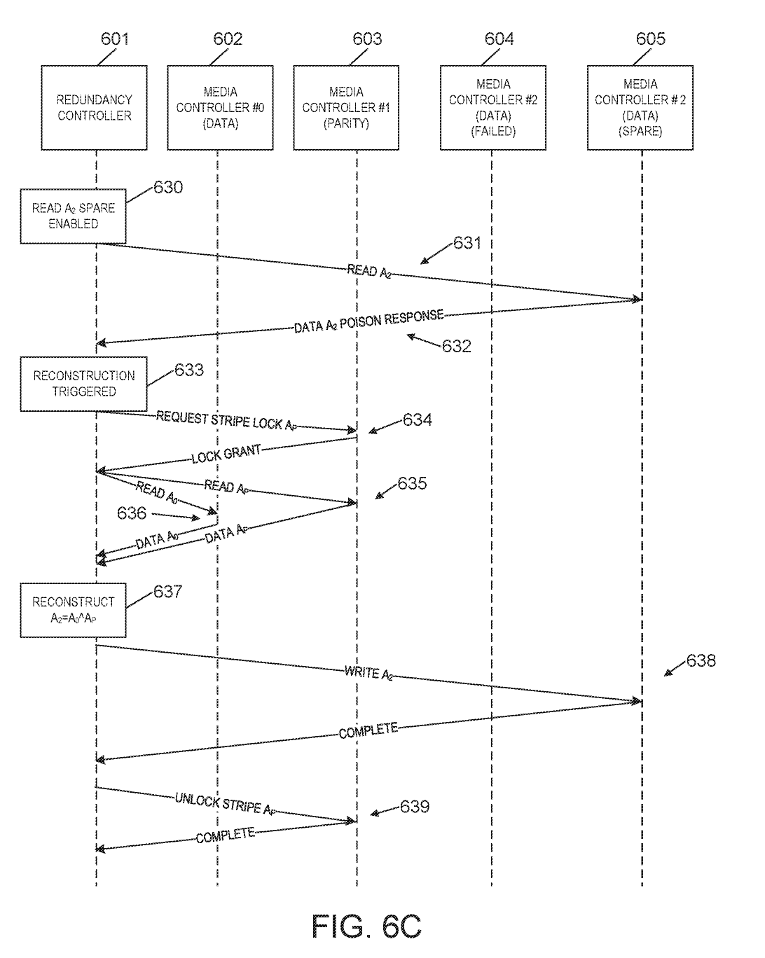

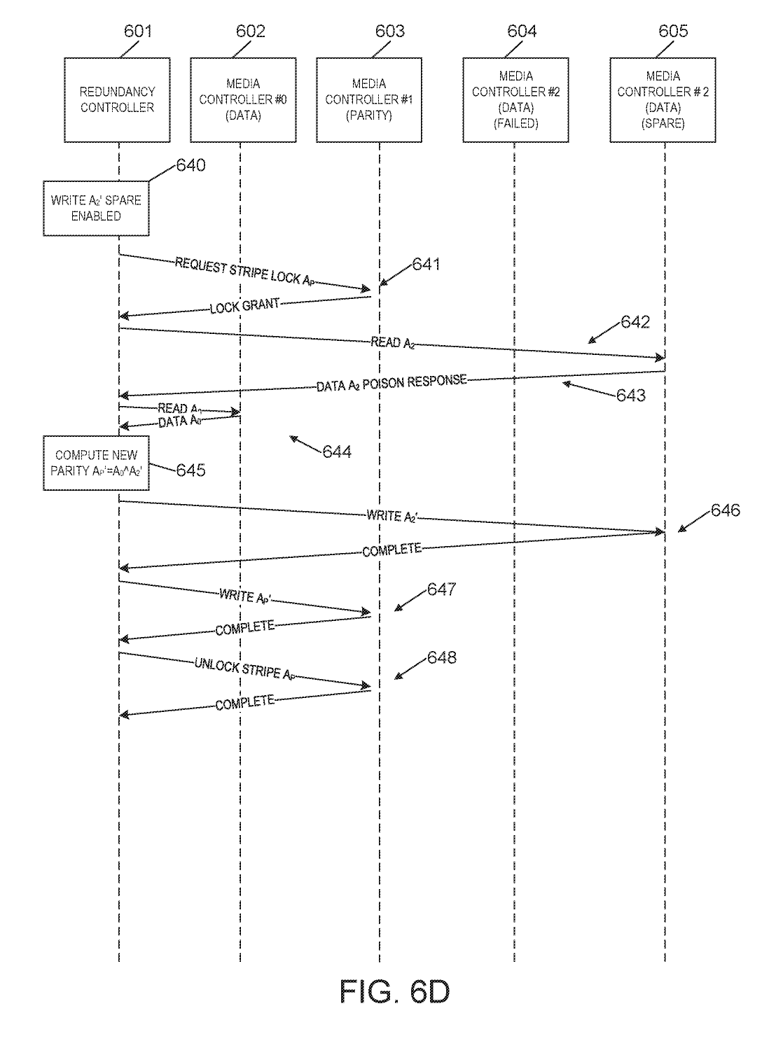

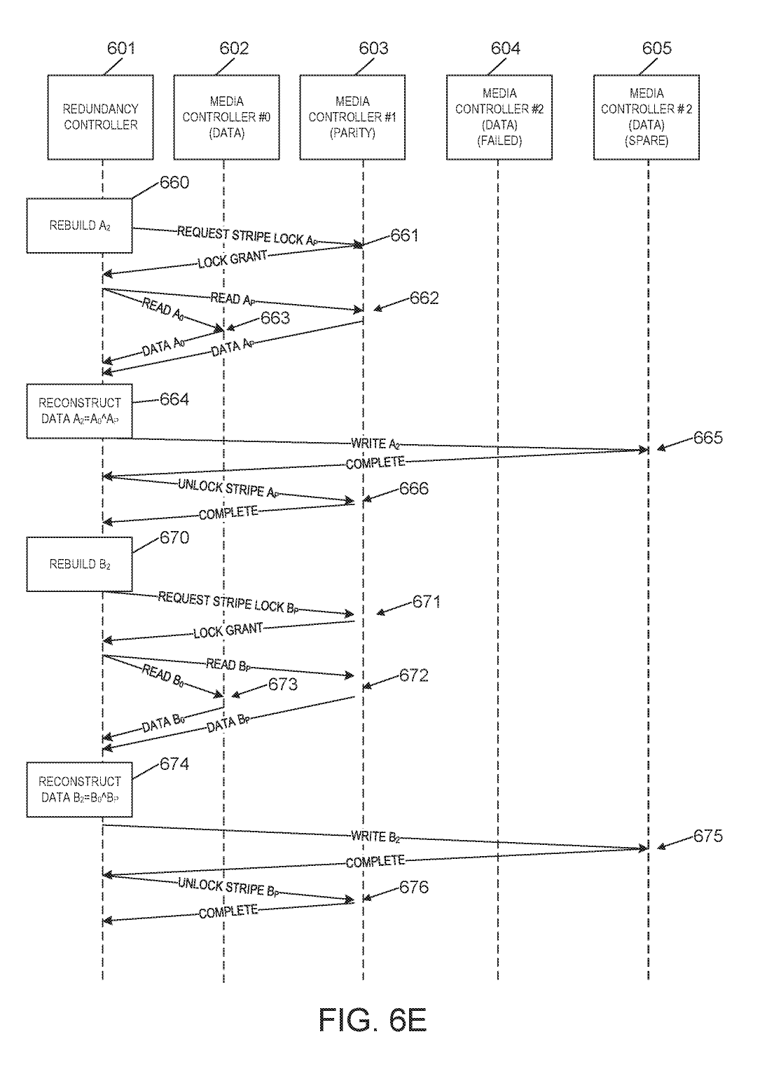

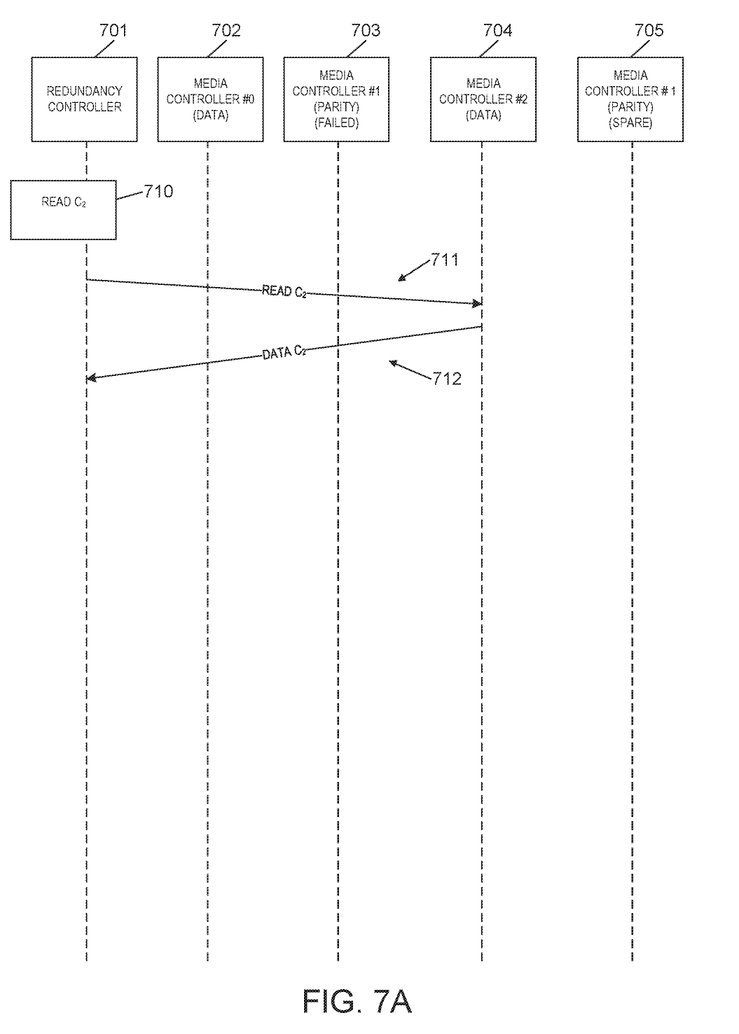

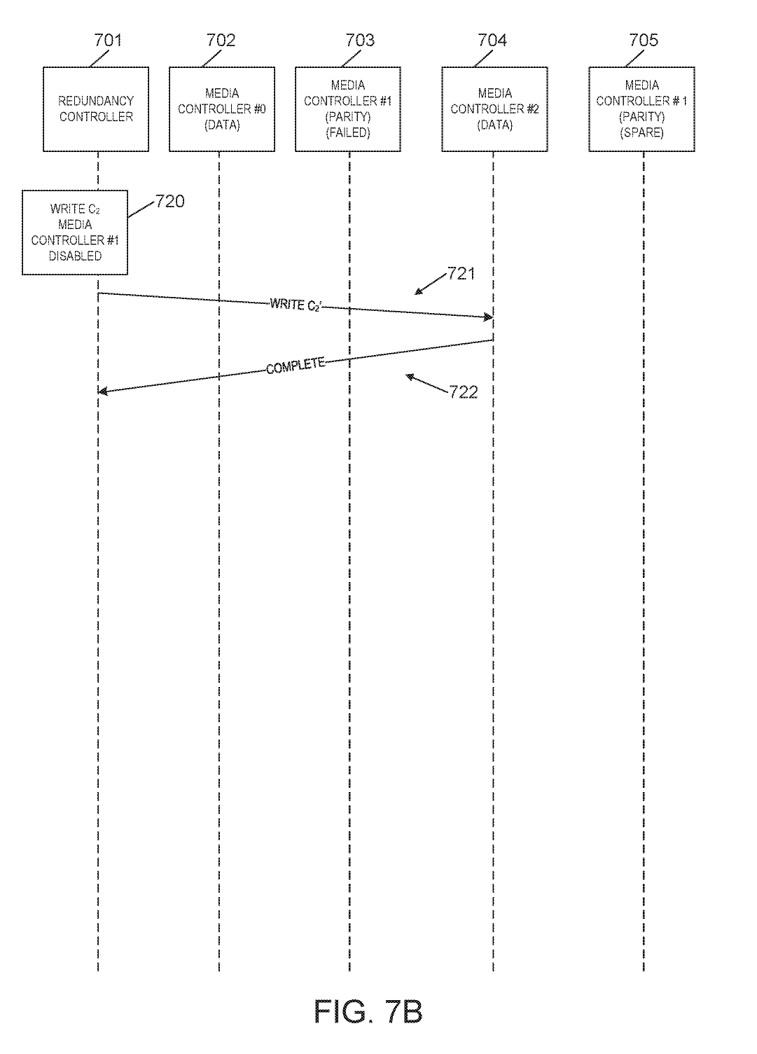

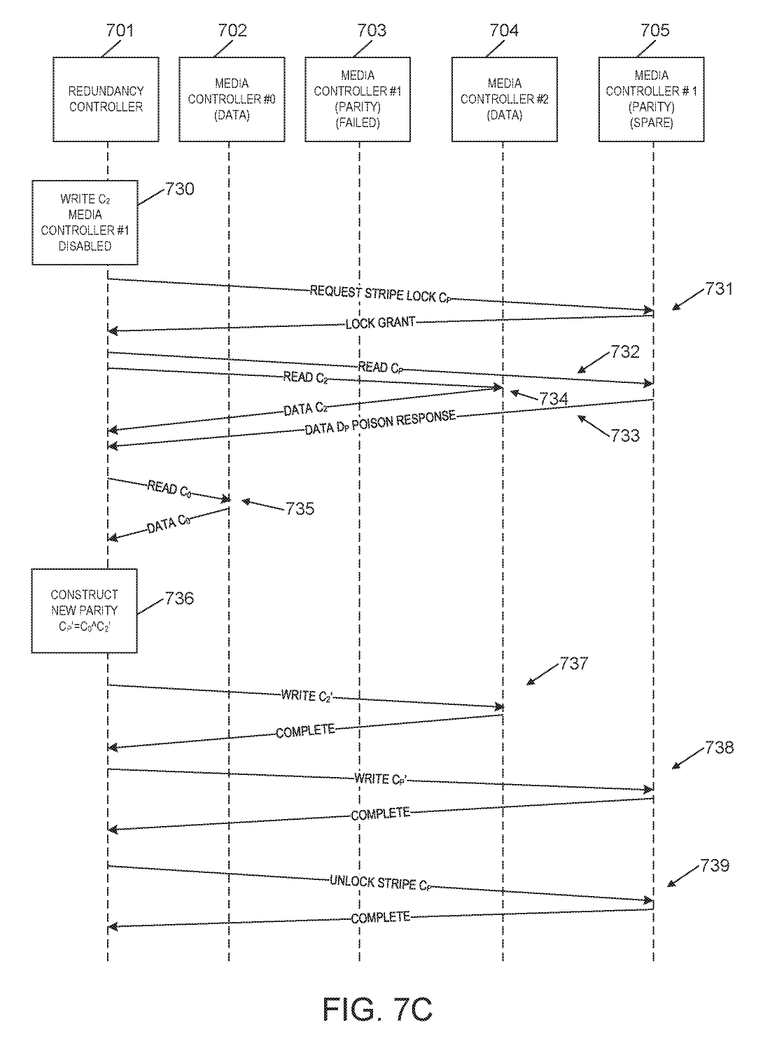

FIGS. 6A-6E are various bounce diagrams illustrating example system operations during various phases of bringing up a spare memory device. More particularly, FIGS. 6A-6E illustrate operations involving stripes having data blocks stored on the failed device. In these examples, data blocks as referred to as block Nᵢ, where N indicates the stripe and i indicates the device storing the block. Parity blocks are referred to as block N_{P}.

For example, the system of FIG. 1 may operate as illustrated in the diagrams. In this example environment, non-atomic RAID sequences require acquiring a stripe lock from the media controller 603 for the memory device storing the parity data for the stripe. For example, a redundancy controller 601 obtains the stripe lock before reading from multiple drives to reconstruct a missing or invalid data block or when writing to a stripe.

FIG. 6A illustrates a read operation performed by a redundancy controller 601 storing data on a 2+1 redundant set with two data devices and one parity device. In this example, one of the data devices 604 has failed, and redundancy controller 601 recognizes the failure and does not yet recognize the spare device 605. Accordingly, the redundancy controller 601 is operating in a degraded mode.

At 610, the redundancy controller 601 begins a degraded mode read operation to read block A₂, which was stored on the failed memory device 604. Accordingly, the redundancy controller 601 performs a sequence of operations to enable it to reconstruct A₂ using data A₀ obtained from media controller 602 and parity data Aₚ from media controller 603.

The redundancy controller begins the sequence by requesting 611 the stripe lock for stripe A from media controller 603. After obtaining 612 the lock, the redundancy controller 601 requests 613 and obtains 616 the parity block A_{P} from media controller 603. Additionally, the redundancy controller 601 requests 614 and obtains 615 the data block A₀ from media controller 602.

In operation 617, redundancy controller 601 reconstructs the desired data block A₂ using the data block A₀ and the parity block A_{P}. For example, the redundancy controller 601 may reconstruct the data block A₂ by performing a bitwise exclusive or (XOR) operation on the blocks, where A₂=A₀̂A_{P}.

Afterwards, the redundancy controller 601 unlocks the stripe by sending 618 an unlock instruction to media controller 603. Upon receiving the unlock instruction, the media controller 603 may acknowledge 619 that the stripe has been unlocked for future operations.

FIG. 6B illustrates a degraded mode write operation 620 before the redundancy controller 603 recognizes the spare media controller 605. To perform the degraded mode write operation to write a block A₂ that would have been written to the failed device 604, the redundancy controller updates the parity data for the stripe to allow the missing block A₂ to be reconstructed later.

Because the operation will require modifying the parity block, the redundancy controller requests 621 and obtains 622 the lock for the stripe A from the parity media controller 603. After obtaining the lock, the redundancy controller 601 requests 623 and obtains 624 the data A₀ for the block.

The redundancy controller 601 uses the obtained data block A₀ and the data block A₂′ that would have otherwise been written to the device 604 to construct 625 a new parity block A_{P}′. In this example, the redundancy controller constructs the new parity block A_{P}′ by XORing the two data blocks, A_{P}′=A₀̂A₂′.

After constructing 625 the new parity block, it is written 626 to the parity media controller 603. After receiving 627 the acknowledgement from the parity media controller 603, the redundancy controller unlocks 628 the stripe lock.

FIG. 6C illustrates a read operation 630 performed after the redundancy controller 601 recognizes the device 605. The read targets a data block A₂ that originally resided on the failed device 604, and so now resides on the spare device 605. In this example the spare device 605 has been just brought online, so all data on spare device 605 has been tagged as invalid. The illustrated flow occurs whether or not the device 605 has been instructed to commit writes.

The read operation 630 begins by sending a read request 631 for data block A₂ to the device 605. This initial read request requires accessing only a single device, so it may be performed without acquiring the stripe lock for stripe A. However, all data on the spare device 605 has been invalidated, and therefore, the media controller 605 responds with an indication 632 that the data A₂ is not safe to consume. For example, the media controller 605 may respond with a message that the request data A₂ is poisoned.

The receipt of the poison response 632 triggers a reconstruction operation 633 to reconstruct the data A₂. The reconstruction operation proceeds as described with respect to FIG. 6A. The redundancy controller 601 obtains 634 the stripe lock, reads 635 the parity data A_{P}, and reads 636 the other data block A₀. The controller 601 reconstructs 637 the data A₂ by XORing A_{P} and A₀. After reconstructing A₂, the redundancy controller 601 attempts to restore redundancy by writing 638 A₂ back to media device 605. After the restoring write 638, the redundancy controller unlocks 639 the stripe and the operation 630 completes.

If the media controller 605 had been instructed to commit writes, then the restoring write 638 is committed and subsequent attempts to read A₂ are successful. However, if the media controller 605 had not been instructed to commit writes, then the restoring write 638 is not committed. In this case, subsequent attempts to read A₂ repeat the illustrated flow.

FIG. 6D illustrates a write operation 640 to write data A₂′ to device 605. The write targets a data block that originally resided on the failed device 604, and so now resides on the spare device 605, and the corresponding parity block resides on device 603. The write operation 640 begins with obtaining 641 the stripe lock for stripe A from parity media controller 603. After obtaining 641 the stripe lock, the redundancy controller 601 requests 642 the old data A₂ from media controller 605 to use in constructing the new parity block A_{P}′. However, because the data on device 605 has initialized as poison, the device 605 returns 643 a poison response. This triggers the controller 601 to use the data from the remaining device to construct the new parity block A_{P}′.

The redundancy controller 601 reads 644 the data A₀ from the media controller 602. Data A₀ and A₂′ are used to compute 645 a new parity block A_{P}′ by XORing A₀ and A₂′. The new data block A₂′ and new parity block A_{P}′ are written 646, 647 to media controller 605 and media controller 603, respectively. After writing, the stripe is unlocked 648.

If operation 640 is performed before the spare device 605 begins committing write operations, then the write 646 is not committed. Accordingly, a subsequent attempt to read block A₂′ will proceed as illustrated in FIG. 6C. However, if the operation is performed after the spare device 605 begins committing write operations, then the data A₂′ may subsequently be read directly from the device 605 as normal.

FIG. 6E illustrates a rebuild process that may be performed after all redundancy controllers recognize the spare device 605. In this example, the redundancy controller 601 walks down a set of stripes and rebuilds the blocks for device 605.

The example process begins with rebuilding 660 block A₂. To rebuild block A₂, the stripe lock for stripe A is obtained 661 from the parity media controller 603. The parity data A_{P} is obtained 662 from parity media controller 603 and the data A₀ is obtained 663 from media controller 602. This information is used to reconstruct 664 data A₂ by XORing A₀ with A_{P}. Once data A₂ is reconstructed 664, it is written 665 to device 605, and the stripe A is unlocked 666.

After rebuilding 660 block A₂, the redundancy controller 601 rebuilds block B₂ for stripe B. The controller 601 obtains 671 the lock for stripe B, and reads 672. 673 the parity block B_{P} and data block B₀. Once the data and parity blocks are obtained, the redundancy controller 601 reconstructs 674 block B₂ using B_{P} and B₀ by XORing the blocks. After reconstructing block B₂, it is written 675 to memory device 605 and the stripe is unlocked 676.

FIGS. 7A-7C are various bounce diagrams illustrating example system operations during various phases of bringing up a spare memory device. More particularly, FIGS. 7A-7C illustrate operations involving stripes having parity blocks stored on the failed device.

FIG. 7A illustrates a redundancy controller 701 reading 710 a data block C₂ of a stripe C from a media device 704. This operation 710 proceeds in the same manner whether or not the parity device 703 has failed or the spare device 705 has been brought online.

As described above, reading is a primitive operation that does not require a stripe lock. Accordingly, the read operation 710 in degraded mode proceeds in the same manner as a read operation in normal mode. The operation 710 proceeds by the redundancy controller 701 sending 711 a read request for C₂ to device 704. The media controller 704 returns 712 the data block A₂ and the operation 710 completes.

FIG. 7B illustrates the redundancy controller 701 writing 720 a data block C₂′ to device 704 in degraded mode. Because the parity device 703 has failed, the write 720 may be performed as a primitive operation where only a single 704 is accessed. Accordingly, the write 720 may be conducting without acquiring a lock. The write 720 proceeds by the redundancy controller 720 sending 721 the data C₂′ in a write request. The media controller 704 acknowledges 722 the write and the operation 720 completes.

FIG. 7C illustrates the redundancy controller 701 writing 730 a data block C₂′ to device 705 in normal mode. In this example, device 705 has been brought online to replace device 703, its contents have been invalidated using poison flags, and the redundancy controller 701 has been instructed to recognize device 705.

The write operation 730 begins by obtaining 731 the stripe lock for stripe C. The redundancy controller requests 734 data block C₂ and requests 732 parity block C_{P}. However, the request 732 is responded to 733 with a message that the parity block C_{P} is poisoned. Accordingly, the redundancy controller 701 recognizes that it cannot perform the normal procedure of generating the new parity block C_{P}′ using C_{P} and C₂.

Instead, the redundancy controller 701 reads C₀ 735 from device 702. Then, the controller 701 constructs 736 the new parity block C_{P}′ by XORing C₁ and C₂′. It then writes C₂′ 737 to device 704 and C_{P}′ 738 to device 705. After writing the blocks, the redundancy controller 701 unlocks the stripe 739 and the operation 730 completes.

If operation 730 is performed before the spare device 705 begins committing write operations, then the write 738 is not committed. Accordingly, a subsequent attempt to write block C₂′ will proceed as illustrated in FIG. 7C. However, if the operation 730 is performed after the spare device 705 begins committing write operations, then the write may proceed as normal.

In some implementations, certain exchanges illustrated in FIGS. 6A-7C may be combined into combined operations. For example, implementations may provide a request stripe lock and parity data message, which is responded to with a lock grant and the parity data for the requested stripe. This message and its response might be used in place of arcs 611, 612, 613 and 616 in FIG. 6A, arcs 661 and 662 of FIG. 6E, or arcs 731, 732 and 733 of FIG. 7C. As another example, implementations may provide a combined write parity data and unlock stripe message, which is responded to with an acknowledgment. For example, such a message may be used in place of arcs 647 and 648 of FIG. 6D and arcs 738 and 739 of FIG. 7C.

As described above, in some implementations, the data blocks that make up stripes may have different sizes than cache lines. For example, each block may be multiple cache lines. In some cases, reads and writes of cache line-sized sub-blocks may be performed using primitive operations that access only the portions that will be modified. In other cases, reads and writes of cache line-sized sub-blocks may be performed using primitive operations that access entire blocks.

With sub-cache line access and block-sized primitives, the redundancy controllers may perform writes by reading the entire block followed by writing back the entire block, including the cache line portion that is modified and the preexisting cache line portions that are not being modified. For example, in FIGS. 6B and 6D, operations 625 and 645 to construct A_{P}′ would be preceded by a read operation to read block A_{P}. As another example, in FIG. 7B, the write operation 720 would be to write a single cache line within block C₂. The write 721 would be proceeded by a read operation to read the entire block C₂.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. A method, comprising:
instructing a media controller of a memory device to invalidate each memory region of a set of memory regions;
instructing a set of redundancy controllers to include the memory device in a redundant set of memory devices;
after instructing the set of redundancy controllers to include the media controller, instructing the media controller to enable writes.

2. The method of claim 1, further comprising:
after instructing the media controller to enable writes, instructing a redundancy controller to begin a rebuild operation.

3. The method of claim 1, further comprising:
prior to instructing the set of redundancy controller to include the memory device, instructing the media controller to ignore writes.

4. The method of claim 1, further comprising instructing the media controller to enable writes after a period of time subsequent to instructing a last redundancy controller to include the memory device, the period of time being sufficient for any in-flight degraded mode operations to complete.

5. A method, comprising:
tagging a set of memory regions as invalid;
in a first mode of operation, receiving but not committing write commands for memory regions of the set of memory regions;
transitioning to a second mode of operation; and
in the second mode of operation, receiving and committing write commands for memory regions of the set of memory regions.

6. The method of claim 5, wherein the set of memory regions are a set of cache line sized memory regions.

7. The method of claim 5, further comprising tagging the set of memory regions as invalid by setting a poison bit associated with each element of the set of memory regions.

8. The method of claim 7, further comprising not committing write commands by not unsetting corresponding poison bits after writing data specified by the uncommitted write commands.

9. The method of claim 5, further comprising not committing write commands by dropping write data specified by the uncommitted write commands.

10. The method of claim 5, further comprising receiving an instruction to tag the set of memory regions as invalid from a system controller.

11. The method of claim 10, further comprising receiving an instruction to transition to the second mode of operation from the system controller.

12. A memory device, comprising:
a set of blocks, each block having a corresponding validity tag; and
a media controller to operate in:
a first mode of operation where received write commands are not committed; and
a second mode of operation where received write commands are committed.

13. The memory device of claim 12, wherein the validity tags comprise poison bits or bad check bits.

14. The memory device of claim 12, further comprising:
an interface to receive a command to transition from the first ode of operation to the second mode of operation.

15. The memory device of claim 14, wherein the interface is to receive a second command to invalidate the set of memory regions by tagging each memory region with the corresponding invalid tag.
